(19) United States
(12) Patent Application Publication
(10) Pub. No.: US 2024/0400004 A1
(43) Pub. Date: Dec. 5, 2024

(54) PNEUMATIC APPARATUS FOR A SENSOR APPARATUS OF A VEHICLE

(71) Applicant: Continental Automotive Technologies GmbH, Hannover (DE)

(72) Inventors: Stefan Duras, Male Ozorovce (SK); Petr Novak, Prague (CZ); Dirk Ringler, Friedewald (DE); Michael Beuschel, Stammham (DE)

(73) Assignee: Continental Automotive Technologies GmbH, Hannover (DE)

(21) Appl. No.: 18/691,414

(22) PCT Filed: Sep. 5, 2022
(86) PCT No.: PCT/DE2022/200202

§ 371 Date: Mar. 12, 2024

(30) Foreign Application Priority Data
Sep. 13, 2021 (DE) 10 2021 210 086.4

(51) Int. Cl. B60S 1/54; B60S 1/56; G01S 7/497

(52) U.S. Cl. CPC B60S 1/54; B60S 1/56; G01S 7/497; G01S 2007/4977

(57) ABSTRACT

A pneumatic apparatus for applying an air flow to an exposed surface of a sensor apparatus of a vehicle. In order to provide a pneumatic apparatus which can efficiently and evenly apply an air flow to larger surfaces, the apparatus comprises a housing configured to extend in the installed state along at least one edge of the exposed surface and has at least one row of nozzles spaced apart from one another and each have a nozzle inlet and a nozzle outlet and which are adapted to simultaneously eject compressed air in the direction towards the exposed surface.

### CROSS-REFERENCE TO RELATED APPLICATIONS

The present application is a National Stage Application under 35 U.S.C. § 371 of International Patent Application No. PCT/DE2022/200202 filed on Sep. 5, 2022, and claims priority from German Patent Application No. 102021210086.4 filed on Sep. 13, 2021, in the German Patent and Trade Mark Office, the disclosures of which are herein incorporated by reference in their entireties.

### BACKGROUND

### 1. Field

Aspects and objects consistent with embodiments of the present application relate to a pneumatic cleaning apparatus for cleaning and drying optical surfaces of various sensor apparatus in the external region of a vehicle, in particular cover panels for LIDAR sensors (Light Detection And Ranging).

### 2. Description of Related Art

Surfaces of cover panels, lenses and similar of optical sensors of a vehicle must always be kept clean for optimal functionality. If such surfaces are arranged so as to be exposed in the exterior region of the vehicle, they are greatly exposed to environmental influences, regularly become soiled and must be cleaned using a special cleaning apparatus.

To this end, it is known to use cleaning apparatuses with nozzles of the type used in headlight or windscreen cleaning systems, which spray a pressurized cleaning fluid onto the surface to be cleaned.

Here it is important to remove the cleaning fluid from the surface as quickly and completely as possible, since residual fluid droplets can also negatively affect the function of optical sensors, for example by deflecting and scattering the light.

Uncontrolled drying of the surface by natural environmental effects, such as travel wind, sunshine etc., is slow and unreliable. In addition, after drying, the cleaning fluid may leave stains which should be avoided for both functional and also aesthetic reasons.

To avoid this, it is known to combine fluid-based cleaning apparatuses with pneumatic apparatuses, which remove fluid residue from the surface more quickly and in controlled fashion by means of a defined air flow. With regard to the relevant prior art, reference is made by way of example to EP 2 949 520 A1.

Such combined cleaning apparatuses are however extremely complex and susceptible to fault, require a comparatively large installation space in the direct vicinity of the sensor, and lead to high production and assembly costs owing to a large number of individual components and mounting operations.

Such pneumatic apparatuses have individual, point-like nozzles or sources of the compressed air jets and are thus able to reliably apply a sufficiently strong air flow to only comparatively small surface regions. For satisfactory treatment of large surfaces such as in particular LIDAR cover panels, they are not optimally suited.

LIDAR sensors, for functional reasons, have transmitting and receiving units arranged side by side. For this reason they require comparatively large, wide cover panels, which are often larger than, for example, a lens of an average camera by a factor of 10-30 or even more. Such large surfaces to be cleaned present particularly great challenges for associated pneumatic apparatuses.

### SUMMARY

Aspects and objects of embodiments consistent with the present application relate a pneumatic apparatus which can efficiently and evenly apply an air flow in particular to larger surfaces while avoiding the above-mentioned disadvantages.

### BRIEF DESCRIPTION OF THE DRAWINGS

Aspects and objects of the embodiments of the present application will be more clearly described with respect to the drawings, in which:

FIG. 1 is a diagram illustrating a pneumatic apparatus according to an embodiment;

FIG. 2 is a diagram illustrating a front view of a longitudinal sectional view of a pneumatic apparatus according to FIG.an embodiment; and

FIG. 3 is an enlarged view of a cross section of the pneumatic apparatus according to FIG.an embodiment.

### DETAILED DESCRIPTION OF THE EMBODIMENTS

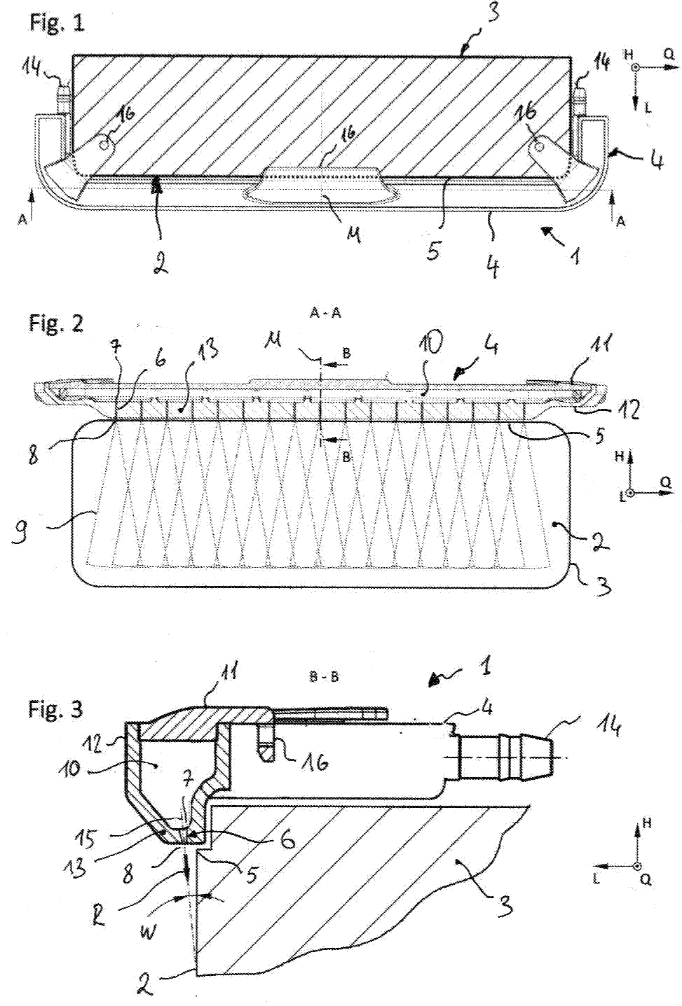

FIG. 1 shows, by way of example and in highly simplified form, a LIDAR sensor apparatus 3 having an associated pneumatic apparatus 1 according to the disclosure in the installed state, in a top view along a vertical axis H of the vehicle.

The apparatus serves to dry the surface 2 with a controlled air flow following a cleaning process by means of a separate cleaning apparatus (not shown here), after driving through water or in rain, as well as optionally to blow away loose and light dirt particles.

The surface 2 to be cleaned of the illustrated sensor apparatus 3 or of the LIDAR has the form of a rounded rectangle. In practice, such cover panels may often also be trapezoid.

The narrow elongate U-shaped housing 4 of the apparatus 1 runs in a frame-like manner along the longer edge 5 of the surface 2 and extends over the entire surface 2 and beyond.

In the housing 4 there is formed an internal channel 10 (see FIG. 2, 3), which has a connection 14 at each of its two opposite ends. The two connections 14 serve to simultaneously supply the channel 10 with compressed air from an external compressed air source (not shown here).

Depending on the application, a compressor, a compressed air store or other pneumatic sources may for example be used as a compressed air source.

The apparatus 1 may be briefly activated after every fluid-based cleaning process, in order to be able to remove the residual cleaning fluid from the surface 2 as quickly and evenly as possible. It may however also be permanently operated, in order for example, during wet weather conditions, to form a protective air film over the surface 2 which deflects the flying water droplets and prevents them from hitting the surface 2.

The fastening interfaces 16, which in this exemplary embodiment are in the form of three lugs with eyelets, serve to fix the cleaning apparatus 1 to the vehicle or to the sensor apparatus 3, depending on the concrete form of the product.

FIG. 2 shows the pneumatic apparatus 1 together with the sensor apparatus 3 in a front view along the vehicle longitudinal axis L. The housing 4 is here depicted in a sectional view through an internal channel 10. The channel 10 extends along the entire housing 4 and is connected at each of its two ends to a pneumatic connection 14 (see FIG. 1).

A plurality of nozzles 6, which are arranged spaced apart from one another in a row along the housing 4 or the surface edge 5, open into the channel 10. On operation of the pneumatic apparatus 1, for example by activation of a compressed air source (not shown here), compressed air jets 9 are simultaneously ejected from the nozzles 6 onto the surface 2. The number and the spacing of the nozzles 6 depends on the size of the surface 2, on the condition that the surface is covered as completely and evenly as possible with an air stream resulting from individual compressed air jets 9.

By simultaneously using two opposite connections 14 at the ends, the necessary internal pressure is built up in the elongate channel 10 more quickly and more evenly. The comparatively large spacing between the first and the last nozzle 6 in the row does not negatively affect the temporal and spatial uniformity in the build-up of the air stream at the surface 2.

For shorter forms of the pneumatic apparatus 1, an embodiment with a single pneumatic connection 14 at the housing 4 would also be conceivable within the scope of the disclosure, which connection, for even air distribution, would then have to be positioned preferably centrally relative to the extent of the channel 10.

In the illustrated preferred embodiment, the nozzles 6 are configured as simple holes or openings in the housing wall 13 of the housing 4, wherein other and more complex nozzle constructions likewise remain allowable within the scope of the disclosure.

In order to reduce pressure losses in the channel 10 and to build up the air stream at the surface 2 more efficiently, the cumulative cross-sectional area of nozzle outlets 8 of all the nozzles 6 should if possible be less than half an averaged cross section of the channel 10.

The apparatus 1 is here arranged in the preferred position above the surface 2 relative to the vehicle vertical axis H. However, positioning to the side of or below the surface 2 likewise remains allowable within the scope of the disclosure.

In FIG. 3, the pneumatic apparatus 1 is shown in cross section through the central plane M (see FIG. 1, 2). Relative to the vertical axis H of the vehicle, the apparatus 1 is arranged in the region of an upper end of the vertically positioned surface 2.

The housing 4 is made from two housing parts 11, 12 which are preferably welded together or alternatively otherwise tightly connected together. The channel 10 is formed in the housing 4 when the two housing parts 11 and 12 are connected together. Each nozzle 6 opens into the channel 10 with a nozzle inlet 7 and tapers, conically in the example shown, along the nozzle axis 15 in the direction of the nozzle outlet 8, as a result of which the air velocity at the outlet is additionally increased in accordance with the Venturi effect.

Relative to the vertical axis H, the nozzles 6 open into the channel 10 at the deepest point thereof, as a result of which condensed water is removed from the channel 10 particularly effectively and the risk of freezing is thus reduced.

The apparatus 1 is configured such that the nozzle outlets 8 of the nozzles 6 are positioned as close as possible to the surface 2. The direction of ejection R of a compressed air jet 9 ejected from the nozzle 6 should preferably be oriented parallel to the surface 2 or, depending on the distance therefrom, at an angle W of between 0° and 30° relative to the surface 2.

By reducing the distance between the nozzle outlet 8 and the surface 2 and by means of a flat angle W, the air flow is guided directly along the surface 2, as a result of which the Bernoulli or Venturi effect is enhanced and flow separation takes place later. As a result, flow can effectively take place around a larger surface region with a lower outlay in terms of energy.

1. A pneumatic apparatus for applying an air flow to an exposed surface of a sensor apparatus of a vehicle, the pneumatic apparatus comprising:
a housing configured to extend in an installed state along at least one edge of the exposed surface; and
at least one row of nozzles, each nozzle among the at least one row of nozzles comprising a nozzle inlet and a nozzle outlet adapted to simultaneously eject compressed air towards the exposed surface.

2. The pneumatic apparatus as claimed in claim 1, wherein the nozzle outlet is positioned in direct vicinity of the exposed surface.

3. The pneumatic apparatus as claimed in claim 2, wherein a direction of ejection of a compressed air jet ejected from the nozzle is oriented at an angle of between 0° and 30° relative to the exposed surface.

4. The pneumatic apparatus as claimed in claim 2, wherein a direction of ejection of a compressed air jet ejected from the nozzle is oriented parallel to the exposed surface.

5. The pneumatic apparatus as claimed in claim 2, wherein the housing has an internal channel which extends along the housing, and the nozzles open into the channel.

6. The pneumatic apparatus as claimed in claim 5, wherein a cumulative cross-sectional area of all the nozzle outlets is less than half an averaged cross section of the channel.

7. The pneumatic apparatus as claimed in claim 6, wherein the housing comprises a first housing part and a second housing part, and the channel is formed by connecting together the first housing part and the second housing part.

8. The pneumatic apparatus as claimed in claim 7, wherein the channel has a connection for supplying with compressed air at each end among opposite ends thereof.

9. The pneumatic apparatus as claimed in claim 8, wherein the nozzle is configured as an opening in a housing wall of the housing.

10. The pneumatic apparatus as claimed in claim 9, wherein the nozzle has a cross section which tapers from the nozzle inlet to the nozzle outlet.

11. The pneumatic apparatus as claimed in claim 10, wherein the housing is arranged, relative to a vertical axis of the vehicle, in the region of an upper end of the exposed surface.

12. The pneumatic apparatus at least as claimed in claim 11, wherein the nozzles, relative to the vertical axis, open into the channel at the deepest point thereof.
